(19) United States
(12) Patent Application Publication
(10) Pub. No.: US 2017/0198519 A1
(43) Pub. Date: Jul. 13, 2017

(54) Method for Manufacturing a Solid Core Panel Door

(71) Applicant: Dan C. Kingery, Lakewood, CO (US)

(72) Inventor: Dan C. Kingery, Lakewood, CO (US)

(21) Appl. No.: 15/403,438

(22) Filed: Jan. 11, 2017

Related U.S. Application Data
(60) Provisional application No. 62/277,131, filed on Jan. 11, 2016.

(51) Int. Cl. E06B 3/72; G05B 19/19; E06B 3/70

(52) U.S. Cl. CPC E06B 3/72; E06B 3/7001; G05B 19/19; G05B 2219/45044

(57) ABSTRACT

A method for manufacturing solid core, panel doors by cutting a panel pocket into a solid core door according to a main routing path. Additionally, a decorative panel is cut from a piece of material according to a panel routing path. Once the panel pocket and the decorative panel have been cut, the decorative panel is bound within the panel pocket; preferably using an adhesive. A plurality of stops is then perimetrically bound about the decorative panel and the panel pocket in order to form an aesthetic border around the decorative panel. Preferably, a computer numerical control machine is utilized to cut the panel pocket into the solid core door and the decorative panel from the piece of material.

The current application claims a priority to the U.S. Provisional Patent application Ser. No. 62/277,131 filed on Jan. 11, 2016.

### FIELD OF THE INVENTION

The present invention relates generally to doors. More specifically, the present invention is a method for manufacturing doors that have the look, weight, and feel of a traditional stile and rail door without the worry of stile and rail separation.

### BACKGROUND OF THE INVENTION

Traditional stile and rail doors are still quite popularly in use today. However, an issue that these doors face is stile and rail separation. Stile and rail separation can occur due to excessive amounts of stress place on the door, old age, weather conditions, and many other factors. In many cases, the separation of the stile and rail only creates an unpleasant aesthetic. However, in some cases where the separation is more extreme, the separation may cause door jams, as the stile and/or rail with be unable to fit within the door frame. Fixing the separation between the stile and rail may be an option, however, it can be frustrating and time consuming. Meanwhile, replacing the door altogether can be quite costly.

In an effort to overcome the deficiencies of stile and rail doors, yet maintain a similar appearance, straight inlay processes have been used to construct doors. However, in most straight inlay process, the plane of the door slab remains the same for the stile, rail, and panel. Furthermore, the straight inlay process does not allow for the option of a flat panel door. While straight inlay processes allow for stile and rail type doors, such processes do not provide a high variability in regards to the design of the panels and the depth of the panels.

Therefore it is an object of the present invention to solve the issue of stile and rail separation without sacrificing the benefits of a traditional stile and rail door. It is another object of the present invention to allow for the higher variability in design options in the manufacture of stile and rail like doors; such as the option of having a flat panel door, which cannot be achieved with an inlay process. The solid core, panel door that is produced using the present invention has the look, weight, and feel of a traditional stile and rail door without the worry of ever having stile and rail separation. The present invention also has the benefit of creating a true recessed panel just like a traditional stile and rail door.

### BRIEF DESCRIPTION OF THE DRAWINGS

FIG. 1 is a perspective view of a solid core, panel door constructed using the method of the present invention.

FIG. 2 is an exploded view of the solid core, panel door, wherein the panel pocket and the subsequent panel pocket are both cut into the first surface of the solid core door.

FIG. 3 is a side sectional view of the solid core, panel door, wherein the panel pocket is cut into the first surface and the subsequent panel pocket is cut into a second surface of the solid core door.

FIG. 4 is a flowchart depicting the steps for constructing a solid core, panel door according to the present invention.

FIG. 5 is a flowchart thereof, further depicting steps for utilizing a computer numerical control machine to cut the panel pocket into the solid core door, and to cut the decorative panel from the piece of material.

FIG. 6 is a flowchart thereof, further depicting steps for adhering the decorative panel to the solid core door.

FIG. 7 is a flowchart thereof, further depicting steps for adhering the plurality of stops.

FIG. 8 is a flowchart thereof, further depicting steps for cutting the subsequent panel and binding a subsequent decorative panel.

FIG. 9 is a flowchart thereof, further depicting steps for cutting the subsequent panel into an opposite side of the solid core door, and for binding the subsequent decorative panel.

### DETAIL DESCRIPTIONS OF THE INVENTION

All illustrations of the drawings are for the purpose of describing selected versions of the present invention and are not intended to limit the scope of the present invention.

The present invention is a method for manufacturing solid core, panel doors. The present invention allows for the production of solid core, panel doors that are designed in the essence of stile and rail doors. However, the solid core, panel doors produced through the present invention have superior strength compared to stile and rail doors and alleviate the issue of stile and rail separation.

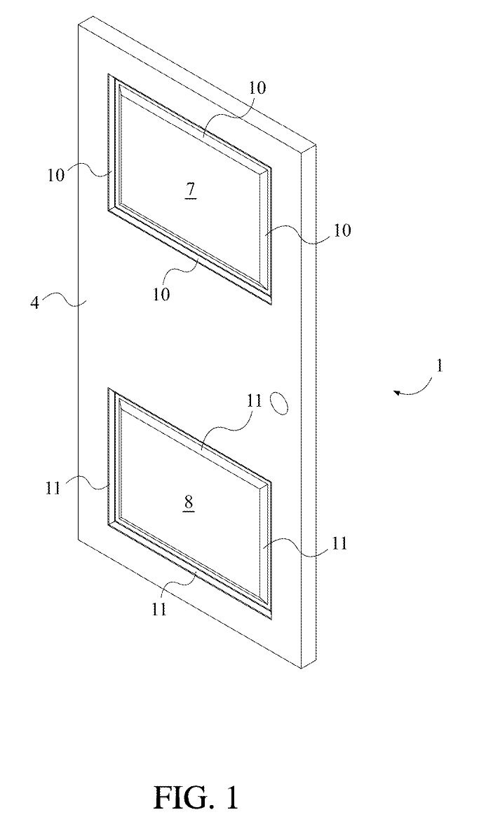

The present invention modifies a solid core door 1, such that the solid core door 1 can be inlayed with one or more decorative panels, as depicted in FIG. 1. In the preferred embodiment of the present invention, a computer numerical control (CNC) machine is utilized to modify the solid core door 1 and form the one or more decorative panels. The present invention is hereinafter described in reference to using the CNC machine, however, it is possible for other tools to be used in order to achieve the same results.

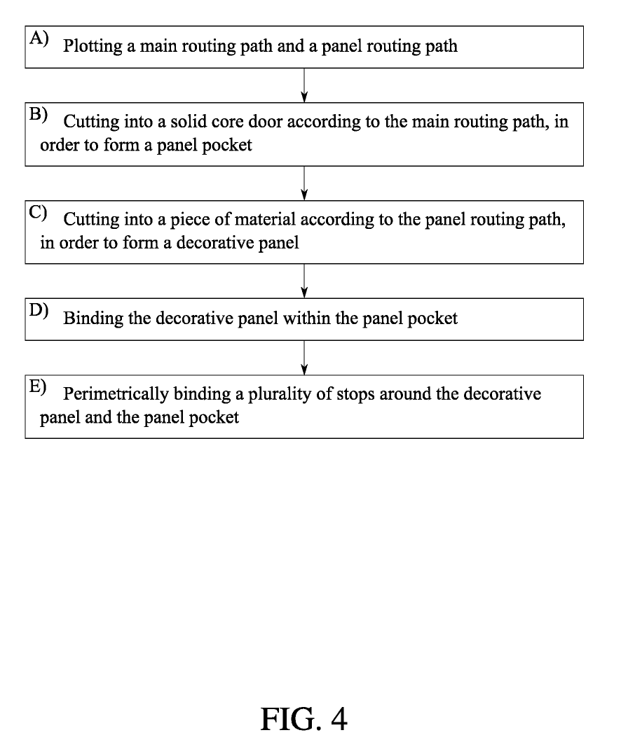

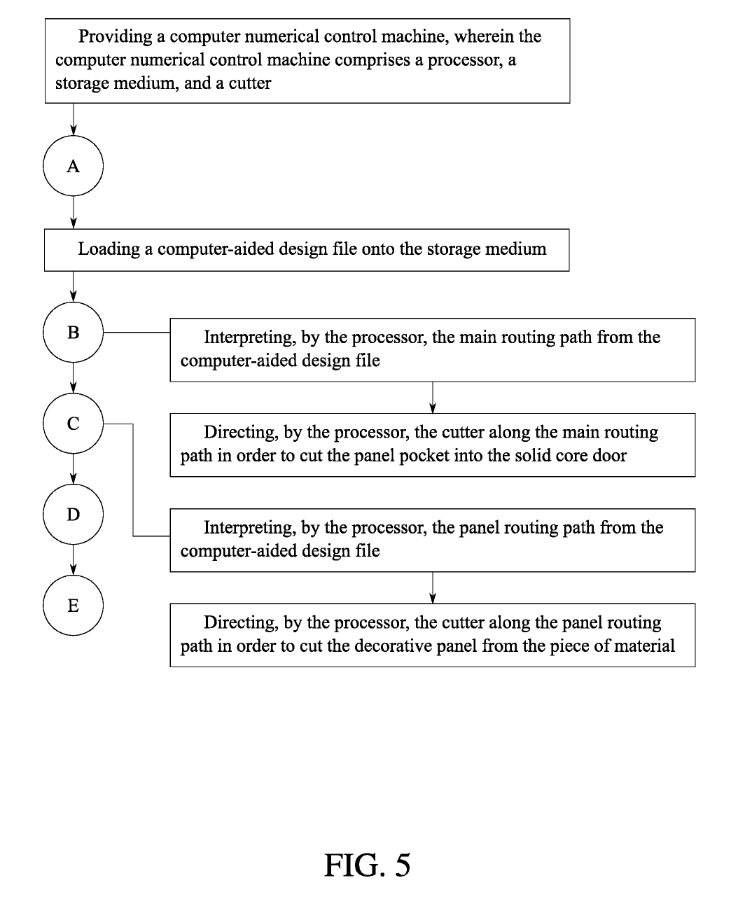

In reference to FIG. 4, first a main routing path and a panel routing path are plotted. The main routing path is utilized for cutting the solid core door 1, while the panel routing path is utilized for cutting the one or more pieces of material. When using the CNC machine, the main routing path and the panel routing path are plotted using a computer and saved in a computer-aided design file. In reference to FIG. 5, the computer-aided design file is loaded onto a storage medium of the CNC machine, wherein the computer-aided design file is accessible by a processor of the CNC machine.

The following outlines the process for installing a single panel in the solid core door 1. In reference to FIG. 4-5, first, a cut is made into the solid door according to the main routing path, in order to form a panel pocket 2. To make the cut, the solid core door 1 is loaded into the CNC machine, wherein the processor interprets the main routing path from the computer-aided design file. In turn, the processor directs a cutter of the CNC machine along the main routing path in order to cut the panel pocket 2 into the solid core door 1.

In further reference to FIG. 4-5, second, a cut is made into a piece of material according to the panel routing path, in order to form a decorative panel 7. In the preferred embodiment of the present invention the piece of material is medium-density fiberboard (MDF); particularly for the paintability properties of MDF. However, it is possible for the piece of material to be any other suitable material. The piece of material is loaded into the CNC machine, wherein the processor interprets the panel routing path from the computer-aided design file. In turn, the processor directs the cutter along the panel routing path in order to cut the decorative panel 7 from the piece of material.

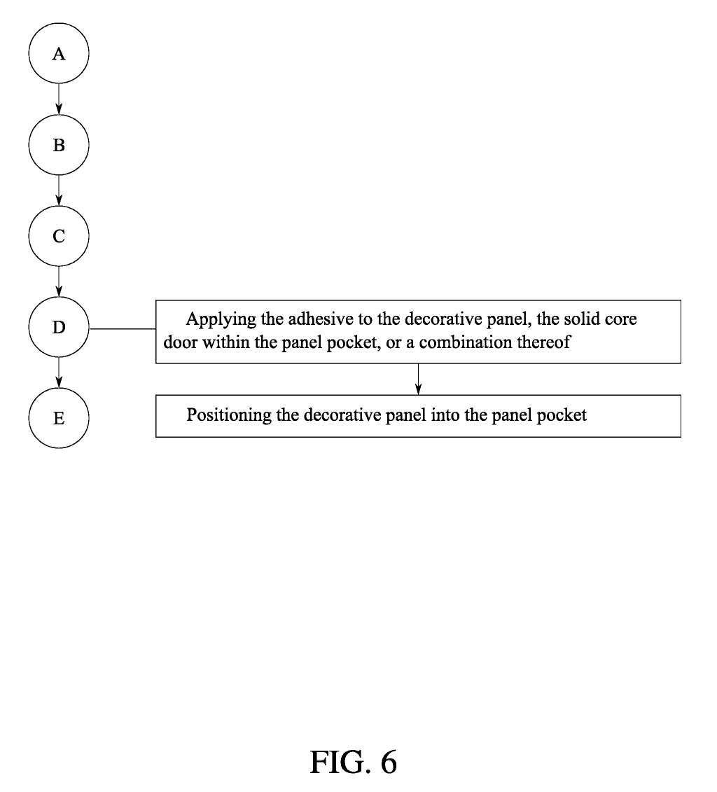

In reference to FIG. 4 and FIG. 6, once the decorative panel 7 is cut from the piece of material, the decorative panel 7 is bound within the panel pocket 2. In the preferred embodiment of the present invention, an adhesive is utilized to bind the decorative panel 7 to the solid core door 1, within the panel pocket 2. The adhesive can be applied to the decorative panel 7, the solid core door 1 within the panel pocket 2, or to both the decorative panel 7 and the solid core door 1. Once the adhesive has been applied, the decorative panel 7 is positioned into the panel pocket 2 and the adhesive is allowed to set. Clamps, weights, or other similar mechanisms may be used to hold the decorative panel 7 in place while the adhesive sets.

A plurality of stops 10 is then installed around the perimeter of the decorative panel 7 and the panel pocket 2. Each of the plurality of stops 10 is cut from a length of material. In the preferred embodiment of the present invention, the length of material used to construct the plurality of stops 10 is identical to the piece of material used to construct the decorative panel 7. However, it is possible for the length of material and the piece of material to be different materials.

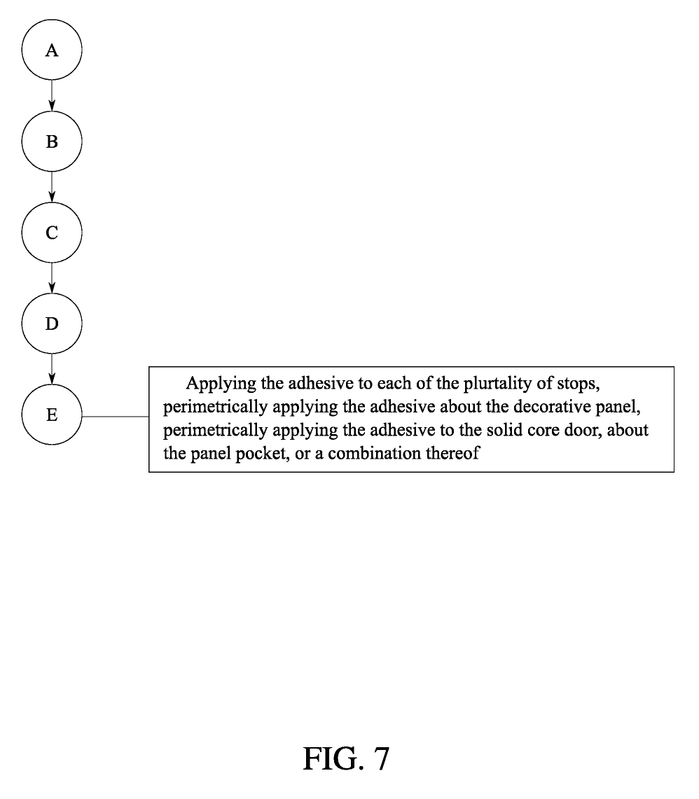

In reference to FIG. 4 and FIG. 7, the plurality of stops 10 is perimetrically bound around the decorative panel 7 and the panel pocket 2 in order to create an aesthetic border. Similar to securing the decorative panel 7 in place, in the preferred embodiment of the present invention, the plurality of stops 10 is bound using an adhesive. The adhesive can be perimetrically applied about the decorative panel 7, perimetrically applied to the solid core door 1 about the panel pocket 2, applied to the each of the plurality of stops 10, or a combination thereof. Once the adhesive has been applied to the desired locations, each of the plurality of stops 10 is positioned onto the decorative panel 7 and/or the solid core door 1.

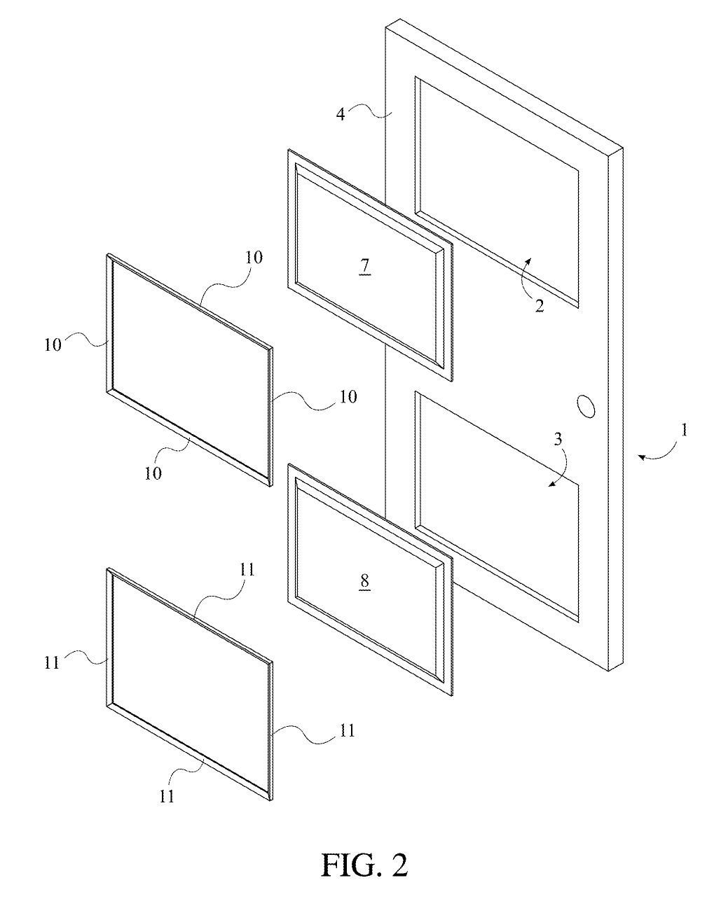

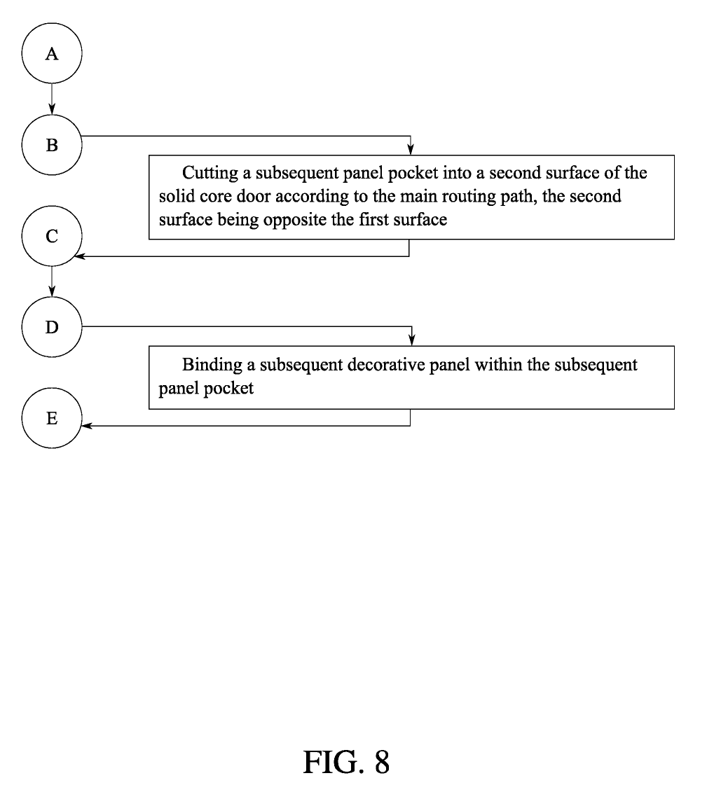

The process described above is for creating a single aesthetic panel assembly that is positioned about a first surface 4 of the solid core door 1; the panel pocket 2 being cut into the first surface 4. However, it may be desirable to create multiple aesthetic panel assemblies. In such a case, the main routing path outlines more than one pocket panel. In reference to FIG. 8, once the panel pocket 2 has been cut from the solid core door 1, a subsequent panel pocket 3 is cut into the first surface 4, as depicted in FIG. 2, according to the main routing path. When using the CNC machine, the processor guides the cutter to the location for creating the subsequent pocket panel in the solid core door 1. The processor then proceeds to direct the cutter along the main routing path in order to form the subsequent pocket.

Once the subsequent panel pocket 3 has been cut, a subsequent decorative panel 8 is cut from the piece of material. The subsequent decorative panel 8 can be cut using the panel routing path, if the subsequent decorative panel 8 is identical to the decorative panel 7. However, if the design of the subsequent decorative panel 8 is to be different than the design of the decorative panel 7, then a subsequent panel routing path is utilized. The processor of the CNC machine interprets the panel routing path from the computer-aided design file, and in turn directs the cutter along the subsequent panel routing path in order to cut the subsequent decorative panel 8 from the piece of material.

In reference to FIG. 8, the subsequent decorative panel 8 is then bound within the subsequent panel pocket 3. The adhesive is applied to the subsequent decorative panel 7 or to the solid core door 1, within the subsequent panel pocket 3, and the subsequent decorative panel 8 is then positioned into the subsequent panel pocket 3. A subsequent plurality of stops 11 is then perimetrically bound about the subsequent decorative panel 8 and the subsequent panel pocket 3. The adhesive is perimetrically applied about the subsequent decorative panel 8, perimetrically applied to the solid core door 1 about the subsequent panel pocket 3, applied to the each of the subsequent plurality of stops 11, or a combination thereof. Once the adhesive has been applied to the desired locations, each of the subsequent plurality of stops 11 is positioned onto the subsequent decorative panel 8 and/or the solid core door 1.

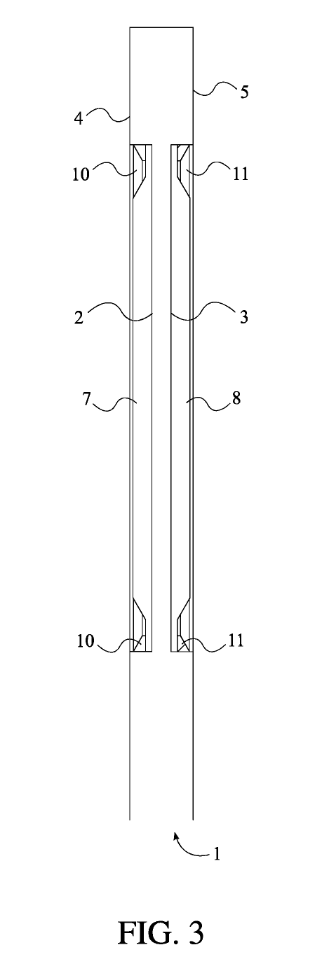

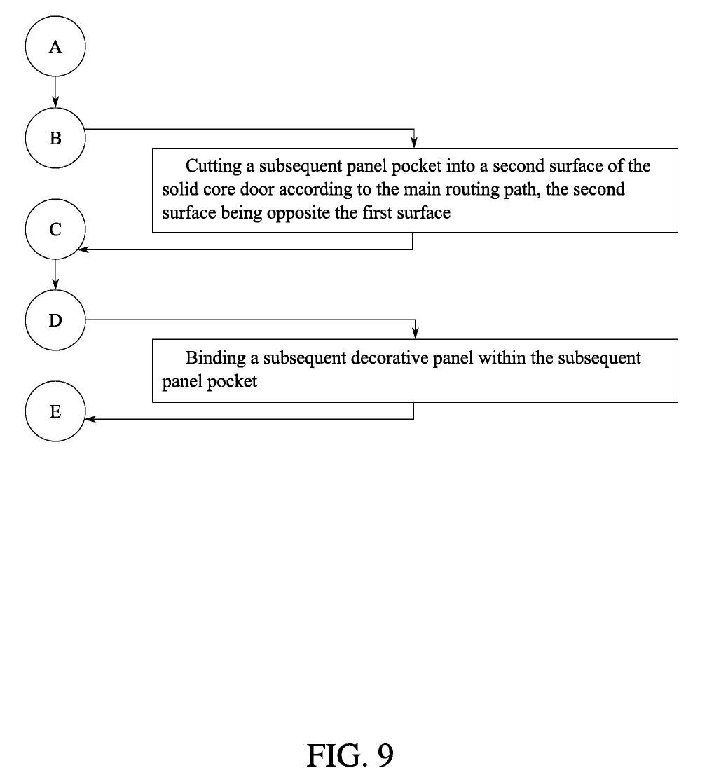

It may also be desirable to form aesthetic panel assemblies about a second surface 5 of the solid core door 1, as depicted in FIG. 3; the second surface 5 being opposite the first surface 4 (i.e. the front and back of the solid core door 1). In reference to FIG. 9, in such a case, the subsequent panel pocket 3 is cut into the second surface 5 of the solid core door 1. The solid core door 1 may have to first be removed from the CNC machine, rotated, and the re-loaded into the CNC machine. Once the subsequent panel pocket 3 has been formed into the second surface 5, the subsequent decorative panel 8 is bound within the subsequent panel pocket 3, and the subsequent plurality of stops 11 is installed.

The above processes are then repeated as many times as necessary in order to form the desired number of aesthetic panel assemblies.

Although the invention has been explained in relation to its preferred embodiment, it is to be understood that many other possible modifications and variations can be made without departing from the spirit and scope of the invention as hereinafter claimed.

What is claimed is:

1. A method for manufacturing a solid core, panel door, the method comprises the steps of:
plotting a main routing path and a panel routing path;
cutting into a solid core door according to the main routing path, in order to form a panel pocket;
cutting into a piece of material according to the panel routing path, in order to form a decorative panel;
binding the decorative panel within the panel pocket; and
perimetrically binding a plurality of stops around the decorative panel and the panel pocket.

2. The method for manufacturing a solid core, panel door, the method as claimed in claim 1 further comprises the steps of:
providing a computer numerical control machine being programmed with the main routing path; and
cutting into the solid core door with the computer numerical control machine.

3. The method for manufacturing a solid core, panel door, the method as claimed in claim 1 further comprises the steps of:
providing a computer numerical control machine being programmed with the panel routing path; and
cutting into the piece of material with the computer numerical control machine.

4. The method for manufacturing a solid core, panel door, the method as claimed in claim 1, wherein the decorative panel is bound within the panel pocket with an adhesive.

5. The method for manufacturing a solid core, panel door, the method as claimed in claim 4 further comprises the steps of:
applying the adhesive to the decorative panel; and
positioning the decorative panel into the panel pocket.

6. The method for manufacturing a solid core, panel door, the method as claimed in claim 4 further comprises the steps of:
applying the adhesive to the solid core door, within the panel pocket; and
positioning the decorative panel into the panel pocket.

7. The method for manufacturing a solid core, panel door, the method as claimed in claim 1, wherein each of the plurality of stops is bound to the decorative panel and the solid core door with an adhesive.

8. The method for manufacturing a solid core, panel door, the method as claimed in claim 7 further comprises the step of:
applying the adhesive to each of the plurality of stops.

9. The method for manufacturing a solid core, panel door, the method as claimed in claim 7 further comprises the step of:
perimetrically applying the adhesive about the decorative panel.

10. The method for manufacturing a solid core, panel door, the method as claimed in claim 7 further comprises the step of:
perimetrically applying the adhesive to the solid core door, about the panel pocket.

11. The method for manufacturing a solid core, panel door, the method as claimed in claim 1, wherein the panel pocket is cut into a first surface of the solid core door.

12. The method for manufacturing a solid core, panel door, the method as claimed in claim 11 further comprises the steps of:
cutting a subsequent panel pocket into the first surface according to the main routing path; and
binding a subsequent decorative panel within the subsequent panel pocket.

13. The method for manufacturing a solid core, panel door, the method as claimed in claim 11 further comprises the steps of:
cutting a subsequent panel pocket into a second surface of the solid core door according to the main routing path, the second surface being opposite the first surface; and
binding a subsequent decorative panel within the subsequent panel pocket.

14. The method for manufacturing a solid core, panel door, the method as claimed in claim 1 further comprises the steps of:
providing a computer numerical control machine, wherein the computer numerical control machine comprises a processor, a storage medium, and a cutter;
loading a computer-aided design file onto the storage medium;
interpreting, by the processor, the main routing path from the computer-aided design file; and
directing, by the processor, the cutter along the main routing path in order to cut the panel pocket into the solid core door.

15. The method for manufacturing a solid core, panel door, the method as claimed in claim 14 further comprises the steps of:
interpreting, by the processor, the panel routing path from the computer-aided design file; and
directing, by the processor, the cutter along the panel routing path in order to cut the decorative panel from the piece of material.
